(19) United States
(12) Patent Application Publication
(10) Pub. No.: US 2026/0275990 A1
(43) Pub. Date: Sep. 17, 2026

(54) SENSOR DEVICE FOR MONITORING A CENTRIFUGAL PUMP

(71) Applicant: WILO SE, Dortmund (DE)

(72) Inventors: Michael Hubo-Kleiss, Dortmund (DE); Michael Kaliwoda, Dortmund (DE); André May, Dortmund (DE)

(21) Appl. No.: 19/548,658

(22) Filed: Feb. 24, 2026

(30) Foreign Application Priority Data
Mar. 12, 2025 (BE) 2025/5154

(51) Int. Cl. F04D 15/00; F04D 1/00

(52) U.S. Cl. CPC F04D 15/0077; F04D 1/00

(57) ABSTRACT

A sensor device for monitoring a centrifugal pump includes at least one signal input including a current transformer input, an analog input, and/or a digital input, a low power wide area network, LPWAN, radio interface, and a processor-based data processing device, wherein the data processing device is configured to detect at least one monitoring signal characterizing a state of the centrifugal pump at least once per second by means of the at least one signal input, to perform an analyzing and data-reducing pre-processing of the at least one monitoring signal with regard to an alarm state of the centrifugal pump, a statistical evaluation of the state of the centrifugal pump and/or a state monitoring and prediction of the centrifugal pump, and transmitting the at least one pre-processed monitoring signal no more frequently than every 5 minutes via the LPWAN radio interface to a cloud infrastructure set up for post-processing the at least one transmitted, pre-processed monitoring signal.

### CROSS-REFERENCE TO RELATED APPLICATIONS

The present application is based upon and claims the right of priority to BE Patent Application No. 2025/5154, filed on Mar. 12, 2025, the disclosure of which is hereby incorporated by reference herein in its entirety for all purposes.

### TECHNICAL FIELD

The invention relates to a sensor device for monitoring a centrifugal pump, comprising at least one signal input, a low power wide area network (LPWAN) radio interface, and a processor-based data processing device. The invention also relates to a method for monitoring a centrifugal pump using a sensor device, comprising the step of: detecting at least one monitoring signal characterizing a state of the centrifugal pump at at least one signal input of the sensor device.

This innovative technology contributes in particular to the achievement of the United Nations Sustainable Development Goals (SDGs) 9, 11, and 13 by increasing the efficiency and service life of infrastructure (SDG 9), ensuring a reliable water supply in urban and rural areas (SDG 11), and reducing energy consumption and greenhouse gas emissions through optimized pump operation and energy-efficient data transmission (SDG 13).

### FIELD OF THE INVENTION

Centrifugal pumps are widely used in a variety of industrial and commercial applications, particularly in water and wastewater treatment, the chemical industry, and heating and cooling circuits. The functionality and efficiency of centrifugal pumps depend largely on their operating state, so continuous or regular monitoring of their operating parameters is necessary to detect failures or malfunctions at an early stage.

Conventional monitoring systems for centrifugal pumps are often based on wired sensor solutions that are integrated into a central control unit. These monitoring systems enable detailed recording of operating parameters, but require extensive cabling, a permanent power supply, and complex data processing. In addition, such monitoring systems often generate large amounts of data, the transmission and analysis of which requires considerable resources and storage space.

More recently, wireless monitoring solutions have been developed that offer more flexible installation and improved scalability. Mobile communications-based technologies in particular enable data transmission over long distances. However, these technologies pose specific challenges in terms of transmitting data with minimal energy consumption. One problem with conventional solutions is the high frequency of measured value transmissions, which leads to unnecessary energy consumption and high network utilization.

### DESCRIPTION OF THE INVENTION

Based on this situation, the present object is to propose a sensor device for monitoring a centrifugal pump and a corresponding method that enables energy-efficient and wireless data transmission with flexible and even retroactive installation.

The object of the invention is achieved by the features of the independent claims. Advantageous embodiments are given in the dependent claims.

Accordingly, the object is achieved by a sensor device for monitoring a centrifugal pump, with
at least one signal input comprising a current transformer input, an analog input, and/or a digital input, a low power wide area network (LPWAN) radio interface, and a processor-based data processing device, wherein
the data processing device is set up
   at least once every second, by means of the at least one signal input, to detect at least one monitoring signal characterizing a state of the centrifugal pump,
   to perform an analyzing and/or data-reducing pre-processing of the at least one monitoring signal, in particular with regard to an alarm state of the centrifugal pump, a statistical evaluation of the state of the centrifugal pump, and/or a state monitoring and prediction of the centrifugal pump, and
   to transmit the at least one pre-processed monitoring signal no more frequently than every 5 minutes via the LPWAN radio interface to a cloud infrastructure set up for post-processing the at least one transmitted, pre-processed monitoring signal.

In other words, it is a sensor device for monitoring a centrifugal pump, which is equipped in particular with a plurality of signal inputs, including at least one current transformer input, one analog input, or one digital input. The sensor device also comprises an LPWAN radio interface that enables energy-efficient and wireless transmission of data. The processor-based data processing device of the sensor device is configured to receive and process at least one monitoring signal, preferably monitoring signals, from the at least one signal input at short intervals, at least once per second. The recorded monitoring signals are subjected in particular to data-reducing pre-processing. The pre-processing also includes analyzing the monitoring signals with regard to a possible alarm state of the centrifugal pump, a statistical evaluation with regard to a pump state, and/or continuous state monitoring and prediction. After pre-processing, the monitoring signals are sent to a cloud infrastructure at defined intervals of no less than 5 minutes via the LPWAN radio interface. The cloud infrastructure is specifically configured to post-process the transmitted, pre-processed monitoring signals, for example, to analyze them further and, if necessary, to initiate further measures.

The sensor device for monitoring a centrifugal pump comprises at least one signal input, which may be configured as a current transformer input, analog input, and/or digital input, so that the sensor device may detect various types of monitoring signals, for example, electrical current values for power monitoring, analog vibration signals for detecting mechanical irregularities, or digital signals from the centrifugal pump. The current transformer input is preferably provided for connecting a current transformer, also known as a current sensor or current measuring transformer, in order to measure electrical currents and prepare them for further processing. The current transformer converts high electrical currents, which flow through a power connection cable of the centrifugal pump, for example, into smaller, proportional currents or voltages, which may then be reliably and accurately detected by at least one signal input of the sensor device.

An example of a monitoring signal characterizing at least one state of the centrifugal pump is monitoring of a motor current of the centrifugal pump. If an electric motor of the centrifugal pump draws more current than in regular operation, this may indicate mechanical problems such as a blocked shaft, wear, or a defective bearing. To reliably measure this motor current, the current transformer is placed around one of the current-carrying wires of the power connection cable. The current transformer generates a weaker signal, which is fed into the sensor device via the current transformer input and analyzed there. Another possible application is load monitoring in industrial pump systems, where power consumption serves as an indicator of the overall efficiency of the pump system. By continuously recording and analyzing power consumption, the sensor device may detect deviations at an early stage and help to improve the energy efficiency of the pump system and reduce maintenance costs. The advantage of the current transformer input or current transformer is that contactless measurement is possible.

The LPWAN radio interface enables energy-efficient wireless data transmission via protocols such as LoRaWAN, LTE-M, or NB-IoT, making the sensor device particularly suitable for retrofitting in remote or hard-to-reach areas. The at least one monitoring signal describes a state of the centrifugal pump, for example, a current consumption for identifying load changes or frequency spectra for detecting cavitation effects. The at least one monitoring signal is subjected to analyzing and/or data-reducing pre-processing, which may include, for example, fault signal detection by pattern matching, statistical long-term evaluation of operating trends, or predictive maintenance forecasting by detecting deviations from normal operating values.

The term “analyzing pre-processing” means, in particular, that the sensor device examines the incoming monitoring signals to identify meaningful characteristics. For example, the sensor device may detect patterns in power consumption, vibration patterns, or temperature changes that indicate an impending fault such as unbalance, cavitation, or a blocked bearing. This analysis may be based on various methods, such as frequency analysis, in particular Fast Fourier Transformation, statistics, such as mean value or standard deviation, or threshold checks, such as detection of a critical increase in current.

The term “data-reducing pre-processing” means, in particular, that the recorded and analyzed monitoring signals are compressed to such an extent that the monitoring signals may be processed and transmitted with minimal memory and energy consumption without losing relevant information. For example, instead of a continuous current signal with a high sampling rate, the sensor device can only transmit statistical parameters, such as average current per minute, modified waveforms, such as reduced frequency resolution, or binary states, such as “normal operation” or “error.” One example is monitoring the electric motor of the centrifugal pump, where instead of transmitting the entire current curve in real time to the cloud, only the fact that the current consumption is within a normal range or that a significant increase has been detected is reported.

This analytical and/or data-reducing pre-processing minimizes network load, extends the battery life of wireless sensors for detecting at least one monitoring signal, and improves the efficiency of downstream data analysis in the cloud.

The pre-processed monitoring signals are sent to the cloud infrastructure via the LPWAN interface no more frequently than every 5 minutes, which is configured in particular for further analysis, long-term storage, and possible control measures. The processor-based data processing device is, in particular, a central computing module of the sensor device that is responsible for the acquisition, data-reducing analysis, in particular for reducing a subsequently transmitted data volume, and transmission of the monitoring signals as a reduced data volume. The processor-based data processing device typically consists of a microcontroller, MCU, or microprocessor that is specifically configured to process the monitoring signals, in particular in real time, to filter out relevant information by means of pre-processing, and to transmit only essential information.

The cloud infrastructure refers in particular to a networked, scalable IT platform that provides computing power, storage, and/or software services and is accessible via the Internet or private networks. In the sensor device described here, the cloud infrastructure serves in particular as a central data processing and analysis platform that further processes received monitoring signals, stores them long-term, and/or enables intelligent diagnostics. The cloud infrastructure enables powerful data analysis algorithms to evaluate trends, perform historical comparisons, and/or detect critical anomalies, such as impending bearing damage due to increasing irregularities in power consumption. Post-processing may also include, or even take precedence over pre-processing, the statistical long-term evaluation of operating trends or predictive maintenance forecasts. If such an anomaly is detected, the cloud may send an automated maintenance signal to maintenance personnel and/or create a proactive maintenance plan.

Furthermore, the cloud infrastructure may simultaneously store and compare transmitted, pre-processed monitoring signals from hundreds of sensor devices to identify system-wide patterns or fault patterns across multiple locations. The cloud infrastructure may consist of public, private, or hybrid cloud systems. Advantages of the cloud infrastructure include high computing power, scalability, automatic software updates, access from anywhere, and/or the ability to develop more accurate fault diagnoses and maintenance strategies for centrifugal pumps through artificial intelligence, AI, and machine learning. At the same time, the cloud reduces the local hardware requirements of the sensor device, as complex data processing and long-term storage are outsourced to the cloud.

According to a preferred further development, the sensor device comprises two or three current transformer inputs, at least one analog output, at least one digital output, and/or an RS485 interface. The analog input is preferably configured for an input current of 4 to 20 mA and/or an input voltage of 0 to 10 V. The RS 485 interface, also known as EIA-485 or RS-485, is an industry standard for a physical interface for asynchronous serial data transmission. The RS485 interface is preferably configured in accordance with the TIA-485-A standard, in particular in accordance with ANSI/TIA/EIA-485-A-98 (R2003). Furthermore, the sensor device preferably has a USB-C interface, in particular for programming the same, wherein the USB-C interface is preferably configured in accordance with IEC 62680-1-3 July 2016. Such a further development enables versatile integration of the sensor device into different areas of application and/or monitoring and control systems.

According to another preferred embodiment, the analyzing and/or data-reducing pre-processing comprises data compression and/or selection of the at least one monitoring signal. Data compression may be performed, for example, by lossless methods such as delta coding, in which only changes between successive monitoring signals are stored, or by run-length coding, in which long sections of identical monitoring signals are compressed. Alternatively, lossy compression may be used, for example, by Fast Fourier Transform (FFT) to convert time-based monitoring signals into a frequency spectrum, wherein only relevant frequency components are stored and transmitted.

The monitoring signals may be selected, for example, by means of a threshold value method, in which only monitoring signals above or below a defined limit are further processed, or by means of event-based selection, in which the sensor device only transmits monitoring signals when unusual behavior of the centrifugal pump is detected, such as sudden vibrations or power fluctuations. In addition, adaptive selection may be used, in which the recording rate varies depending on the operating status of the centrifugal pump, for example, a higher recording frequency in the event of noticeable changes and a reduced frequency during normal operation. These methods help to increase the energy efficiency of the sensor device, save storage space, and optimize wireless communication, in particular by reducing the amount of data and improving the efficiency of transmission via the LPWAN radio interface.

According to a further preferred embodiment, the analyzing and/or data-reducing pre-processing comprises amplitude and/or time reduction of the at least one monitoring signal. Amplitude reduction may be achieved by quantization, in which continuous monitoring signals are mapped to a limited number of levels so that finer monitoring signal variations are neglected, or by smoothing methods such as moving average filters, which eliminate small fluctuations and retain only relevant monitoring signals. Alternatively, an amplitude clipping method may be used, in which only monitoring signals above or below certain thresholds are stored in order to detect only significant changes in a pump status.

Time reduction may be achieved by downsampling, in which monitoring signals are only recorded at longer time intervals, for example from 1 ms to 100 ms, resulting in less data being generated and processed. Another option is event-driven sampling, in which monitoring signals are only recorded or processed when a specific change in the signal curve is detected, for example, a sudden pressure or vibration deviation in the centrifugal pump. These embodiments significantly reduce the data load, extend the battery life of a battery-powered sensor device, and optimize the use of available bandwidth for wireless transmission via the LPWAN radio interface in order to increase processing and transmission efficiency.

According to another preferred embodiment, a data transmission rate of the at least one monitoring signal is ≥300, 500, 1000, or 2000 greater than that of the at least one transmitted, pre-processed monitoring signal. This configuration allows for a significant reduction in data. The sensor device may collect, analyze, and compress a large amount of raw data as monitoring signals before transmitting only a greatly reduced amount of data as pre-processed monitoring signals to the cloud infrastructure. One example is the monitoring of the power consumption of the centrifugal pump, in which the monitoring signal is recorded as a raw signal with a sampling rate of 10 kHz, while after pre-processing only a compressed status value or a statistical parameter, such as the average or peak value per minute, is transmitted as a pre-processed monitoring signal.

Another example is a vibration sensor that may measure continuously at 1 kHz, wherein summarized information is only sent as a pre-processed monitoring signal when critical thresholds are reached or anomalies occur. Another example is a Fourier analysis of a pump noise, in which only noticeable frequency changes are extracted from millions of raw data points as monitoring signals and transmitted as pre-processed monitoring signals. Such training improves the efficiency of wireless transmission via LPWAN while ensuring that only information relevant to monitoring the centrifugal pump is retained. Specifically, the further processing allows for significant data reduction prior to transmission and conserves bandwidth and energy consumption.

According to a further preferred embodiment, the at least one transmitted, pre-processed monitoring signal is of the Boolean data type. After this further processing, the at least one monitoring signal may only assume two possible states after pre-processing, for example, 0 or 1, true or false, or on or off. This configuration enables maximum data reduction, since instead of complex raw data, only a binary value is sent as monitoring signals, which significantly reduces transmission time and energy consumption. A concrete example is the detection of an alarm state in a centrifugal pump, where the sensor device may continuously measure vibrations, current consumption, or temperature and process these monitoring signals. Instead of sending the monitoring signals with high resolution, only a Boolean value is transmitted, which indicates whether a critical threshold has been exceeded, for example, 1 equals alarm or 0 equals no alarm. Another example is state monitoring based on pattern evaluation, in which an internal model of the sensor device analyzes whether the centrifugal pump is operating in a normal or regular mode or in a faulty mode, and simply sends a Boolean signal as the result, for example, “Pump running properly” equals 0 or “Maintenance required” equals 1. This training is particularly suitable for energy-efficient LPWAN networks, as the data load is reduced to a minimum while still reliably transmitting information relevant to decision-making. In other words, such a binary representation of the monitoring signals significantly reduces the complexity of the transmitted data.

According to another preferred embodiment, the LPWAN radio interface is set up to transmit at least one pre-processed monitoring signal using a Long Range Wide Area Network (LoRaWAN) network protocol, a Long Term Evolution for Machines (LTE-M) network protocol, and/or a NarrowBand IoT network protocol. LoRaWAN is a radio protocol developed specifically for the Internet of Things (IoT) that operates in license-free frequency bands and is optimized for long ranges with low energy consumption, enabling sensors to send monitoring signals over several kilometers to gateways, cloud infrastructure, or the like, for example, to monitor centrifugal pumps in remote industrial facilities without wired infrastructure.

LTE-M is based on the LTE mobile communications standard and offers higher bandwidth and lower latency than LoRaWAN, making it suitable for applications that require more real-time data transmission, such as real-time monitoring of pump vibrations within an urban waterworks. NarrowBand IoT, NB-IoT, on the other hand, is a narrowband mobile communications technology that may penetrate particularly deep into buildings or underground areas, enabling reliable monitoring of centrifugal pumps in basements or shafts. NB-IoT also allows for high scalability with many networked data processing facilities within a network. By supporting these different LPWAN protocols, the sensor device may be flexibly adapted to different use cases by selecting the appropriate transmission technology depending on the infrastructure and requirements.

According to a further preferred embodiment, transmission takes place continuously and/or periodically and/or no more frequently than every 10, 15, 20, 30, or 60 minutes. Such further training enables flexible adaptation to different monitoring requirements. Continuous transmission means, in particular, that the sensor device sends the pre-processed monitoring signal in real time or with minimal delay, which is particularly advantageous in safety-critical applications, for example, when a sudden increase in the power consumption of the centrifugal pump indicates an impending blockage and a warning must be issued immediately.

Periodic transmission, on the other hand, takes place at fixed intervals, such as every 30 minutes or every hour, which is useful for applications that do not require an immediate response, such as long-term analysis of wear patterns or efficiency trends of the centrifugal pump. Limiting the transmission rate to certain minimum intervals, such as 10, 15, or 60 minutes, helps to minimize the energy consumption of the sensor device and network load, especially for battery-powered sensor devices used in areas that are difficult to access. For example, the sensor device in a remote water treatment plant may only send operating parameters of the centrifugal pump every 20 minutes to save energy, while a high-performance industrial centrifugal pump in a factory is monitored continuously or every 10 minutes in order to be able to react to deviations at an early stage.

According to another preferred embodiment, the detection is performed continuously and/or periodically and/or at least every 500, 250, 100, 50, 25, 5, or 1 ms. Continuous recording means, in particular, that the monitoring signal is recorded in real time without interruption, which is particularly important in highly dynamic processes, for example when the centrifugal pump has strong load fluctuations and sudden changes in power consumption or vibrations must be detected. Periodic acquisition, on the other hand, takes place at regular intervals, for example every 100 or 500 milliseconds, which may be sufficient if only long-term trends or medium-term changes, such as a gradual increase in power consumption due to wear, need to be monitored. Choosing a higher sampling rate, for example 1 ms, is particularly relevant for applications where fast events such as pressure surges or cavitation effects must be detected in order to adjust the centrifugal pump control accordingly. A lower sampling rate of 500 ms or more, on the other hand, is useful when only slowly varying operating states need to be checked, for example to determine general energy consumption over longer periods of time. Flexible configuration of the acquisition rate allows the sensor device to be optimized between high data resolution and energy-saving operation, depending on requirements, to ensure application-optimized data acquisition.

According to a further preferred embodiment, the sensor device has a fixing device for arranging the sensor device on a top-hat rail, in particular of a control cabinet. The fixing device may consist of a standardized snap-in or clamp fastening that allows the sensor device to be mounted on the top-hat rail without additional tools and removed again if necessary. The top-hat rail, also known as a DIN rail, is a standardized metal profile rail used in control cabinets and distribution boxes to securely mount electrical and electronic components such as relays, control devices, or sensor devices in a space-saving manner. The top-hat rail is often used in automation technology, plant engineering, or electrical distribution systems. A control cabinet is usually a housing that accommodates and protects electrical and electronic components such as controllers, fuses, or sensors, for example in production facilities, waterworks, or industrial pump systems. By attaching it to the top-hat rail in the control cabinet, the sensor device may be integrated directly into existing control systems, even retrospectively, ensuring a robust and professional installation, for example for monitoring centrifugal pumps in a water treatment plant or in an industrial cooling circuit. In this respect, the further development facilitates compact and standard-compliant installation of the sensor device in industrial environments.

The object of the invention is further achieved by a centrifugal pump comprising a sensor device as described above, wherein the at least one signal input is connected to the centrifugal pump. A centrifugal pump is generally referred to as a flow machine that utilizes a rotary motion and dynamic forces to convey predominantly liquids as fluid. In addition to a tangential acceleration of the liquid, a centrifugal force in radial flow is used for pumping in the centrifugal pump, so that such pumps are also referred to as centrifugal pumps. The centrifugal pump may preferably be used for a hydraulic system in a building or other applications, in particular as a waste water pump.

During the regular operation of the centrifugal pump, a housing of a motor of the centrifugal pump may be arranged above a pump housing, in which the impeller driven by the motor via a shaft is provided for conveying the liquid and the centrifugal chamber. The housing of the motor may be connected to the pump housing in a fixed position and/or may be configured in one piece. The centrifugal pump and the motor may also each have their own shaft, wherein the shafts may be connected to one another via a coupling. Preferably, the shaft protrudes from the housing of the motor into the pump housing on a drive side and/or is fixed to the shaft on the drive side of the impeller. Accordingly, the suction opening for the fluid to be conveyed is preferably arranged at the bottom of the pump housing. Preferably, the housing of the motor and/or the pump housing is made of metal, in particular cast iron or stainless steel, ceramic and/or plastic. The fluid or liquid preferably comprises water or another liquid medium such as waste water. The fluid or liquid may contain solids such as dirt, impurities or waste of any kind, in particular feces, sediments, dirt, sand, or even small pieces of wood, undergrowth, textiles or rags or the like, which may cause a blockage in the pump housing.

The object of the invention is also achieved by a method for monitoring a centrifugal pump by means of a sensor device, comprising the steps of: detecting at least one monitoring signal characterizing a state of the centrifugal pump at at least one signal input of the sensor device at least every second, wherein the signal input comprises a current transformer input, an analog input, and/or a digital input; analyzing and/or data-reducing pre-processing of the at least one monitoring signal, in particular with regard to an alarm state of the centrifugal pump, a statistical evaluation of the state of the centrifugal pump, and/or a state monitoring and prediction of the centrifugal pump; and periodically transmitting the at least one pre-processed monitoring signal no more than once every 5 minutes via a low power wide area network (LPWAN) radio interface of the sensor device to a cloud infrastructure set up for post-processing the at least one transmitted, pre-processed monitoring signal.

According to a preferred further development, the method comprises the step of: post-processing the at least one transmitted, pre-processed monitoring signal using the cloud infrastructure.

Such a further development enables more advanced analyses, long-term data evaluations, and/or intelligent forecasts for centrifugal pump monitoring. Post-processing may include, for example, merging and comparing transmitted, pre-processed monitoring signals over longer periods of time in order to detect wear trends or anomalies that indicate an impending failure of the centrifugal pump. In a water treatment plant, for example, the cloud could determine from the transmitted, pre-processed monitoring signals that the power consumption of the centrifugal pump is slowly increasing, indicating increasing bearing friction, and generate a maintenance recommendation at an early stage. In an industrial cooling system, the cloud may compare historical data to detect that unusual vibrations indicate cavitation or a clogged pipe, allowing targeted measures to be taken. Furthermore, the cloud may perform automatic pattern recognition using machine learning to predict future malfunctions and optimize preventive maintenance strategies. Another example is integration into a higher-level monitoring system that links various sensor devices in a production plant so that correlations between centrifugal pump failures and other pump states may be identified. This cloud-based post-processing significantly improves the efficiency and reliability of centrifugal pump monitoring while reducing the local computing and storage requirements of the sensor device.

According to another preferred embodiment, the analyzing and/or data-reducing pre-processing comprises data compression and/or selection of the at least one monitoring signal.

According to a preferred further development, the analyzing and/or data-reducing pre-processing comprises amplitude and/or time reduction of the at least one monitoring signal.

Further embodiments and advantages of the method result in analogy to the sensor device described above. It is preferred that the sequence of method steps may be varied, unless technically required in an explicit sequence. The aforementioned sequence of method steps is particularly preferred.

### BRIEF DESCRIPTION OF THE DRAWINGS

In the following, the invention is explained in greater detail with reference to the appended drawings with reference to preferred exemplary embodiments.

In the drawings:

FIG. 1 shows a schematic sectional view of a centrifugal pump for carrying out a proposed method according to a preferred exemplary embodiment of the invention,

FIG. 2 shows a schematic arrangement comprising the centrifugal pump according to FIG. 1 and a sensor device for monitoring the centrifugal pump according to the preferred exemplary embodiment of the invention,

FIG. 3 shows a flow diagram for carrying out the proposed method according to the preferred exemplary embodiment of the invention,

FIG. 4 shows a diagram for recording and evaluating monitoring signals for measuring current at the centrifugal pump according to the preferred exemplary embodiment of the invention,

FIG. 5 shows a diagram of a trend analysis for monitoring the power consumption of the centrifugal pump according to the preferred exemplary embodiment of the invention,

FIG. 6 shows a diagram for continuously checking threshold values at signal inputs of the sensor device according to the preferred exemplary embodiment of the invention,

FIG. 7 shows a further diagram for continuously checking threshold values at signal inputs of the sensor device according to the preferred exemplary embodiment of the invention, and

FIG. 8 shows a diagram showing the flow of additional information to a cloud infrastructure downstream of the sensor device according to the preferred exemplary embodiment of the invention.

### DETAILED DESCRIPTION OF THE EXEMPLARY EMBODIMENTS

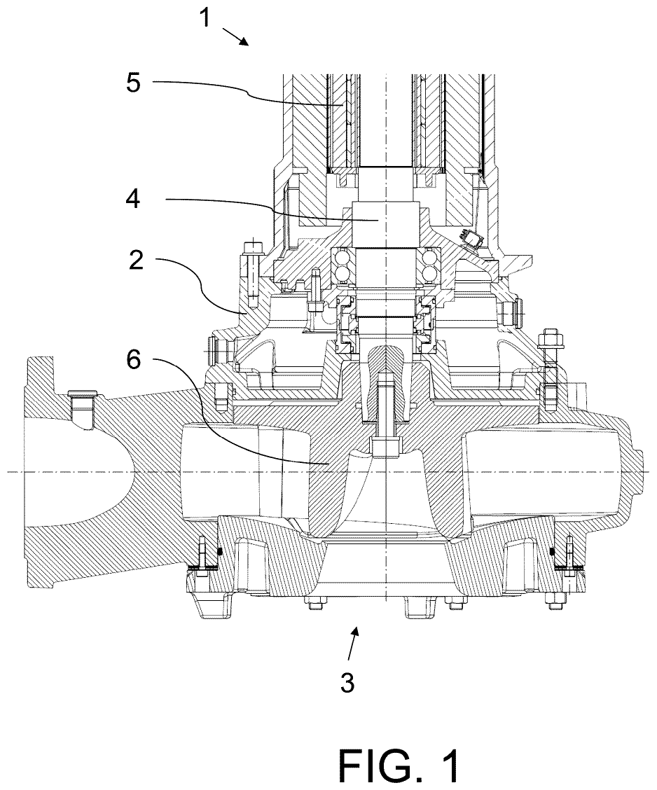

FIG. 1 shows a schematic view of a centrifugal pump 1 for performing a method described below for monitoring the centrifugal pump 1 according to a preferred exemplary embodiment of the invention.

The centrifugal pump 1, formed as a sewage pump, conventionally has a pump housing 2 with a suction opening 3 arranged at the bottom of the pump housing 2 in the figure as an inlet. A rotor 4 is provided in the pump housing 2, which extends vertically in the drawing. The rotor 4 is part of an electric motor 5, shown only in part, which is arranged opposite the suction opening 3. Facing the suction opening 3 is an impeller 6, which is driven by the rotor 4 of the electric motor 5. Furthermore, the centrifugal pump 1 has a control system, not shown in FIG. 1.

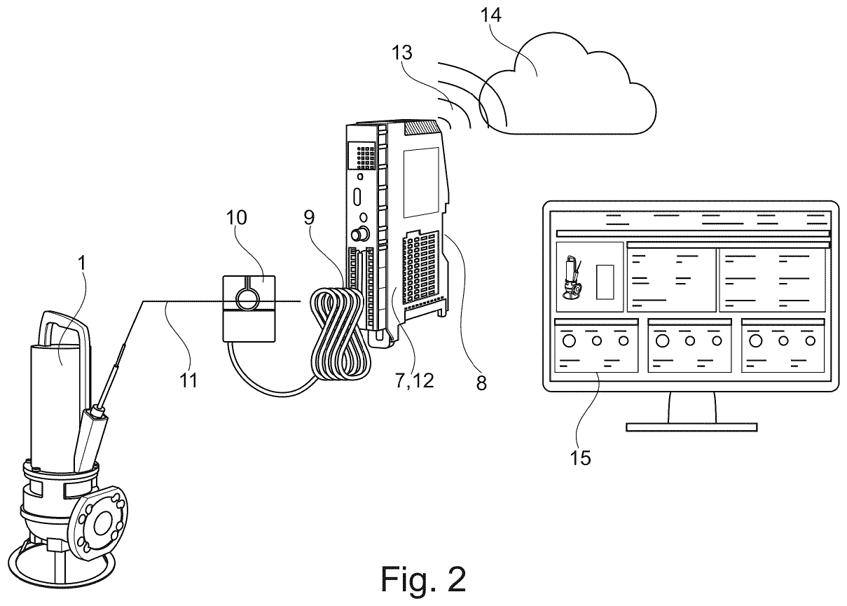

FIG. 2 shows a schematic arrangement comprising the centrifugal pump 1 according to FIG. 1 and a sensor device 7 for monitoring the centrifugal pump 1 according to the preferred exemplary embodiment of the invention. The sensor device 7 has its own housing separate from the centrifugal pump 1, which may be attached to a top-hat rail of a control cabinet (not shown) by means of a fixing device 8. The sensor device 7 may be battery-powered, but in the present case it is supplied with electrical energy by the control cabinet. The sensor device 7 has a plurality of signal inputs 9, which comprise several current transformer inputs, an analog input, and a digital input. In addition, an analog output, at least one digital output, an RS485 interface, and a USB-C interface are provided.

One of the current transformer inputs is connected to a current transformer 10, which detects a current flowing in the mains connection cable 11 of the centrifugal pump 1 at one phase of the mains connection cable 11 as a monitoring signal characterizing a state of the centrifugal pump 1. The sensor device 7 also has a processor-based data processing device 12 configured as a microcontroller, only indirectly visible in FIG. 2, and a low power wide area network (LPWAN) radio interface 13. The data processing device 12 is configured to execute the method steps shown in FIG. 3 for executing the proposed method according to the preferred exemplary embodiment of the invention.

In a first step 100, the monitoring signal characterizing at least one state of the centrifugal pump 1 is detected at least every second by the data processing device 12 at the at least one signal input 9 of the sensor device 7. The at least one monitoring signal may be, as described, the current consumed by the electric motor 5, a rotational speed of the centrifugal pump 1, etc. The detection is performed continuously and periodically, preferably at least every 500, 250, 100, 50, 25, 5, or 1 ms.

In a second step 200, the data processing device 12 performs an analyzing and data-reducing pre-processing of the at least one monitoring signal with regard to an alarm state of the centrifugal pump 1, a statistical evaluation of the state of the centrifugal pump 1, and/or a state monitoring and prediction of the centrifugal pump 1. For this purpose, the analyzing and data-reducing pre-processing comprises data compression and selection of the at least one monitoring signal.

An alarm state of the centrifugal pump 1 occurs, for example, when the sensor device 7 detects critical operating deviations by means of the analyzing pre-processing, which indicate a malfunction, overload, or imminent failure of the centrifugal pump 1. For example, a sudden increase in current consumption indicates a blocked rotor shaft 5 or a damaged bearing, or unusual vibrations indicate cavitation or unbalances. If the temperature of the electric motor 5 rises above a specified limit, overheating of the electric motor 5 may be detected, whereupon an alarm may be triggered and a maintenance message generated. The alarm status may be sent to a higher-level monitoring system via a downstream cloud infrastructure 14 to enable an immediate response.

The statistical evaluation of the centrifugal pump's state refers, for example, to a long-term analysis of the recorded monitoring signals in order to identify mean values, trends, and deviations. For example, the sensor device 7 may record and analyze the average current consumption, speed, or temperature over several weeks in order to detect atypical changes in operation at an early stage. A typical application is to determine an average vibration amplitude over several operating cycles in order to detect gradual changes due to mechanical wear. Similarly, a trend analysis of energy consumption may help identify inefficiencies, such as deposits in pipes that place greater strain on the centrifugal pump 1. The statistical evaluation may serve as a basis for optimized maintenance strategies and help to avoid unplanned downtime.

State monitoring is performed, for example, by continuously analyzing the monitoring signals of centrifugal pump 1 to ensure that the monitoring signals are operating within normal operating ranges. Various measured values such as current consumption, speed, temperature, or vibrations may be monitored in real time and compared with historical data. State prediction, predictive maintenance, allows future faults or maintenance requirements to be predicted to a large extent, for example, using machine learning methods or predefined models based on the recorded monitoring signals. For example, an increase in current consumption at a constant load may be used to predict that centrifugal pump 1 will need to be serviced in a few weeks because bearing damage is imminent. Similarly, regular analysis of vibration frequency spectra may indicate a developing unbalance at an early stage before it leads to critical damage. The combination of condition monitoring and prediction enables efficient maintenance planning, reduces unplanned downtime, and extends the service life of centrifugal pump 1.

In a third step 300, the at least one pre-processed monitoring signal is periodically transmitted no more than once every 5 minutes via the low power wide area network (LPWAN) radio interface 13 of the sensor device 7 to the cloud infrastructure 14, which is set up to post-process the at least one transmitted, pre-processed monitoring signal. The transmission takes place continuously and periodically, and no more frequently than every 10, 15, 20, 30, or 60 minutes. The LPWAN radio interface 13 is set up to transmit the at least one pre-processed monitoring signal using a Long Range Wide Area Network (LoRaWAN) network protocol, a Long Term Evolution for Machines (LTE-M) network protocol, and/or a NarrowBand IoT network protocol. Due to the pre-processing that has taken place beforehand, the data transmission rate of the at least one monitoring signal is ≥300, 500, 1000, or 2000 greater than that of the at least one transmitted, pre-processed monitoring signal.

Transmission no more frequently than every 5 minutes as a transmission interval means, for example, that data aggregation is implemented in the sensor device 7 itself. If, for example, a status change such as centrifugal pump 1 on/off is detected multiple times within the 5-minute transmission interval, the status changes are counted and, up to a certain number, each with its own timestamp, for example, a maximum of 15 status changes in 5 minutes, aggregated in a message transmitted from sensor device 7 to the cloud infrastructure 14, so that the information is not available live, but no information shorter than the transmission interval is lost.

Finally, the at least one transmitted, pre-processed monitoring signal may be post-processed using the cloud infrastructure 14, for example at a control station 15. The post-processing may, for example, comprise merging and comparing transmitted, pre-processed monitoring signals over longer periods of time in order to detect wear trends or anomalies that indicate an imminent failure of the centrifugal pump 1.

It is also conceivable that the pre-processing may be configured from the cloud infrastructure 14, for example, to individually adjust threshold values for changes or events per centrifugal pump 1. In addition, further processing algorithms, such as filter algorithms, could be downloadable from the cloud infrastructure 14 to the sensor device 7 or the data processing device 12 and specifically applicable to individual monitoring signals.

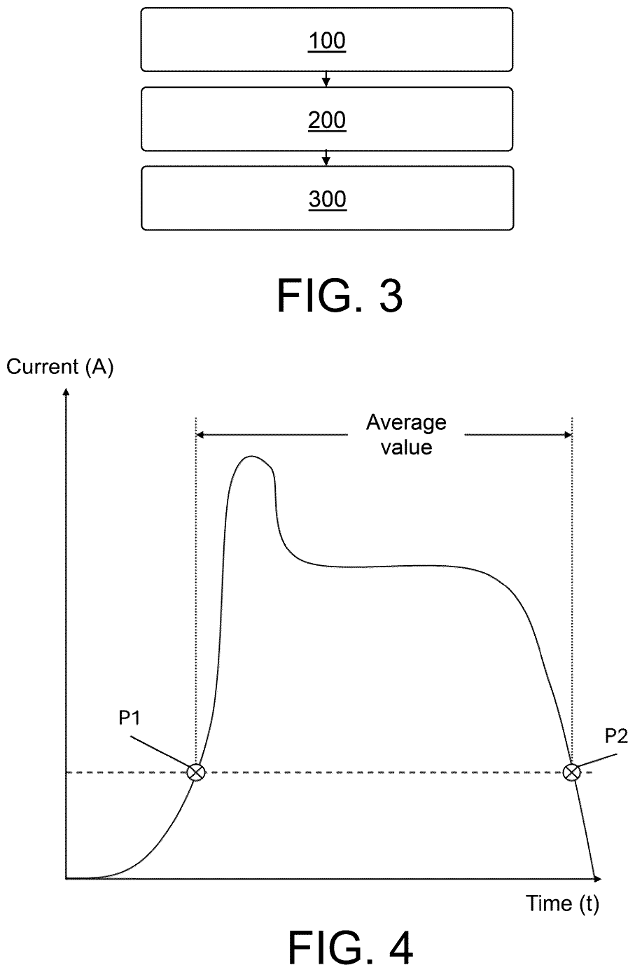

FIG. 4 shows a diagram for recording and evaluating monitoring signals for current measurement at the centrifugal pump 1 according to the preferred exemplary embodiment of the invention. The monitoring signals are present in the form of current at the signal inputs 12 in order to detect operating states of the centrifugal pump 1. The data processing device 12 provides information by means of the analyzing pre-processing when the measured current exceeds a configured threshold value, marked P1 in FIG. 4, or falls below it, marked P2 in FIG. 4, each with a time stamp. The average value of the current between P1 and P2 and during ongoing operation until the next update is displayed. The recorded monitoring signals may be stored persistently in the sensor device 7 in order to survive power failures. In another variant, the standard deviation for an ON phase of the centrifugal pump 1 as well as the height and duration of a switch-on pulse are also recorded and evaluated.

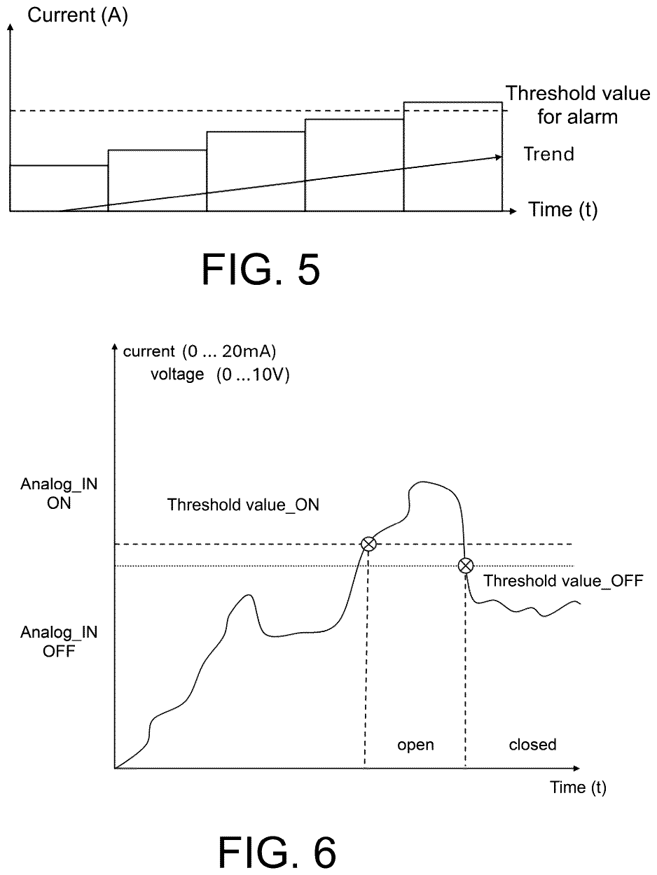

FIG. 5 shows a diagram of a trend analysis for monitoring the power consumption of centrifugal pump 1 according to the preferred exemplary embodiment of the invention. The analysis makes it possible to identify potential problems with centrifugal pump 1 at an early stage. The sensor device 7 or the data processing device 12 provides a counter for the number of switch-on events of centrifugal pump 1 in the last 24 hours, including a possible running cycle at the time of evaluation. The counter is updated during each update cycle and stored persistently in order to survive a power failure. Alternatively, an alarm may be generated on a dashboard provided by the cloud infrastructure 14 based on a simple threshold comparison for an average value, for example, 1.5 times the rated current. In a later step, an additional component of the cloud infrastructure 14 may perform trend analysis of the reported average values to predict problems before an absolute threshold is exceeded.

FIG. 6 shows a diagram for continuously checking threshold values at signal inputs of the sensor device 7 for adjustable threshold values for ON/OFF detection according to the preferred exemplary embodiment of the invention. If the measured monitoring signal is above an ON threshold, an ON event with a timestamp is sent to the cloud infrastructure 14. If the measured monitoring signal then falls below an OFF threshold value, an OFF event with a timestamp is sent to the cloud infrastructure 14. In addition, a time during which the signal input 9 was above the threshold value, known as the ON time, is transmitted and sent to the cloud infrastructure 14 in two versions. As long as the analog input is above the ON threshold value, the time since the threshold value was exceeded is sent every 15 minutes. If the analog input falls below the OFF threshold value, the time between the ON and OFF threshold values is sent.

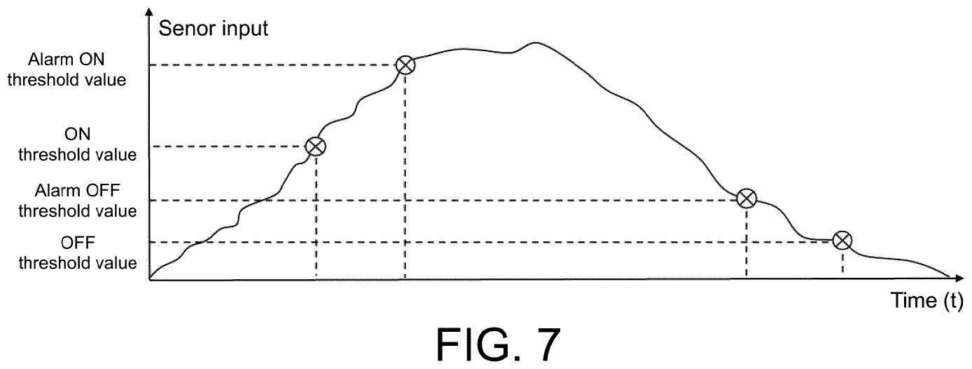

FIG. 7 shows another diagram for continuously checking threshold values at the signal inputs 9 of the sensor device 7 for adjustable threshold values for ON/OFF detection according to the preferred embodiment of the invention, wherein alarm thresholds may be configured so that when the alarm threshold is exceeded, an alarm message with a timestamp is sent to the cloud infrastructure 14. When the alarm threshold is not exceeded, corresponding information with a time stamp is sent to the cloud infrastructure 14 indicating that an alarm is no longer active.

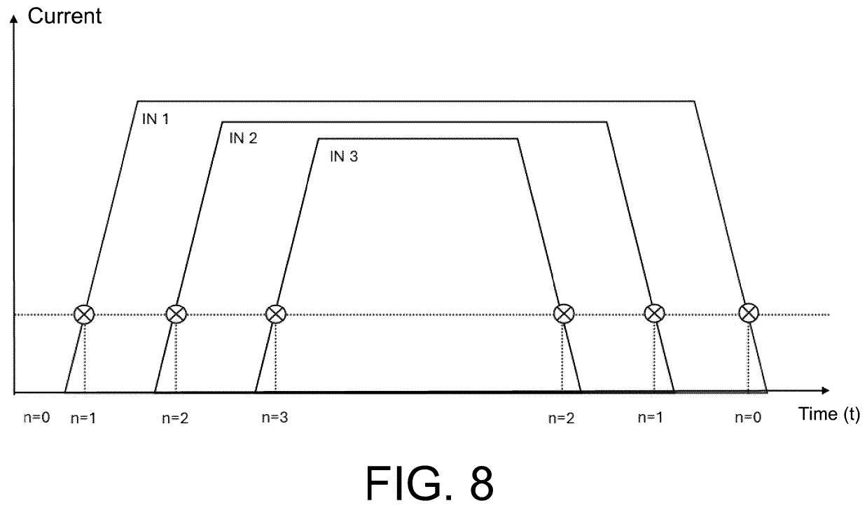

FIG. 8 shows a diagram of the flow of additional information to a cloud infrastructure 14 downstream of the sensor device 7 according to the preferred embodiment of the invention, in order to detect how many centrifugal pumps 1 are running simultaneously. When a centrifugal pump 1 exceeds the threshold value for ON detection, a counter is incremented by one and sent with a timestamp to the cloud infrastructure 14. When a threshold value falls below the threshold value for ON detection, the counter is decremented by 1 and sent with a timestamp to the cloud infrastructure 14.

The described exemplary embodiments are merely examples that may be modified and/or supplemented in a variety of ways within the scope of the claims. Each feature described for a particular exemplary embodiment may be used independently or in combination with other features in any other exemplary embodiment. Each feature described for an exemplary embodiment of a certain category may also be used in a corresponding manner in an exemplary embodiment of another category.

### LIST OF REFERENCE SIGNS

centrifugal pump 1
pump housing 2
suction opening 3
rotor 4
electric motor 5
impeller 6
sensor device 7
fixing device 8
signal input 9
current transformer 10
power connection cable 11
data processing device 12
LPWAN radio interface 13
cloud infrastructure 14
detecting at least one monitoring signal characterizing a state of the centrifugal pump 1 at at least one signal input 9 of the sensor device 7 at least every second 100
performing analyzing and data-reducing pre-processing of the at least one monitoring signal with regard to an alarm state of the centrifugal pump 1, a statistical evaluation of the state of the centrifugal pump 1, and/or a state monitoring and prediction of the centrifugal pump 1 200
periodically transmitting the at least one pre-processed monitoring signal no more than once every 5 minutes via a low power wide area network (LPWAN) radio interface 13 of the sensor device 7 to a cloud infrastructure 14 set up for post-processing the at least one transmitted, pre-processed monitoring signal 300

1. A sensor device for monitoring a centrifugal pump, comprising
an own housing separate from a housing of the centrifugal pump, at least one signal input comprising a current transformer input, an analog input, and/or a digital input, a low power wide area network, LPWAN, radio interface, and a processor-based data processing device, wherein
the data processing device is set up
at least once per second, by means of the at least one signal input, to detect at least one monitoring signal characterizing a state of the centrifugal pump,
to perform an analyzing and data-reducing pre-processing of the at least one monitoring signal with regard to at least one of an alarm state of the centrifugal pump, a statistical evaluation of the state of the centrifugal pump, and a state monitoring and prediction of the centrifugal pump, and
the at least one pre-processed monitoring signal is transmitted no more frequently than every 5 minutes via the LPWAN radio interface to a cloud infrastructure set up for post-processing the at least one transmitted, pre-processed monitoring signal.

2. The sensor device according to claim 1, wherein the sensor device comprises at least one of two or three current transformer inputs, at least one analog output, at least one digital output, and an RS485 interface.

3. The sensor device according to claim 1, wherein the analyzing and data-reducing pre-processing comprises at least one of data compression and selection of the at least one monitoring signal.

4. The sensor device according to claim 1, wherein the analyzing and data-reducing pre-processing comprises at least one of amplitude and time reduction of the at least one monitoring signal.

5. The sensor device according to any claim 1, wherein a data transmission rate of the at least one monitoring signal is ≥300 greater than that of the at least one transmitted, pre-processed monitoring signal.

6. The sensor device according to claim 1, wherein the at least one transmitted, pre-processed monitoring signal is of the Boolean data type.

7. The sensor device according to claim 1, wherein the LPWAN radio interface is configured to transmit the at least one pre-processed monitoring signal by means of at least one of a Long Range Wide Area Network, a LoRaWAN network protocol, a Long Term Evolution for Machines, a LTE-M network protocol and by means of a NarrowBand IoT network protocol.

8. The sensor device according to claim 1, wherein the transmission takes place at least one of continuously and periodically.

9. The sensor device according to claim 1, wherein the transmission takes place no more frequently than every 10 minutes.

10. The sensor device according to claim 1, wherein the detection is performed at least one of continuously and periodically.

11. The sensor device according to claim 1, wherein the detection is performed at least every 500 ms.

12. The sensor device according to claim 1, further comprising a fixing device for arranging the sensor device on a top-hat rail or on a top-hat rail of a control cabinet.

13. A centrifugal pump comprising a sensor device according to claim 1, wherein the at least one signal input is connected to the centrifugal pump.

14. A method for monitoring a centrifugal pump by means of a sensor device having an own housing separate from a housing of the centrifugal pump, comprising the steps of:
detecting at least one monitoring signal characterizing a state of the centrifugal pump at at least one signal input of the sensor device at least every second, wherein the signal input comprises at least one of a current transformer input, an analog input, and a digital input;
performing, analyzing, and data-reducing pre-processing of the at least one monitoring signal with regard to at least one of an alarm state of the centrifugal pump, a statistical evaluation of the state of the centrifugal pump, and a state monitoring and prediction of the centrifugal pump; and
periodically transmitting the at least one pre-processed monitoring signal no more than once every 5 minutes via a low power wide area network, LPWAN, radio interface of the sensor device to a cloud infrastructure set up for post-processing the at least one transmitted, pre-processed monitoring signal.

15. The method according to claim 14, further comprising the step of:
post-processing the at least one transmitted, pre-processed monitoring signal by means of the cloud infrastructure.

16. The method according to claim 14, wherein the analyzing and data-reducing pre-processing comprises at least one of data compression and selection of the at least one monitoring signal.

17. The method according to claim 14, wherein the analyzing and data-reducing pre-processing comprises at least one of amplitude and time reduction of the at least one monitoring signal.
